(19) United States
(12) Patent Application Publication
(10) Pub. No.: US 2012/0188130 A1
(43) Pub. Date: Jul. 26, 2012

(54) ANTENNA FOR WIRELESS COMMUNICATION TERMINAL FOR HEARING AID COMPATIBILITY

(75) Inventor: Byoung-Keon CHO, Seoul (KR)

(73) Assignee: PANTECH CO., LTD., Seoul (KR)

(21) Appl. No.: 13/227,025

(22) Filed: Sep. 7, 2011

(30) Foreign Application Priority Data
Jan. 24, 2011 (KR) 10-2011-0007015

(51) Int. Cl. H01Q 5/01

(52) U.S. Cl. 343/700 MS

(57) ABSTRACT

An antenna having a signal contact point and a ground contact point includes an extension pattern portion to connect the ground contact point and a first point and to connect the signal contact point and the first point; a low-frequency band pattern portion extended from the first point, the low-frequency band pattern having a first length; and a high-frequency band pattern portion extended from the ground contact point, the high-frequency band pattern having a second length that is shorter than the first length.

### CROSS-REFERENCE TO RELATED APPLICATION

This application claims priority from and the benefit under 35 U.S.C. §119(a) of Korean Patent Application No. 10-2011-0007015, filed on Jan. 24, 2011, which is incorporated by reference for all purposes as if fully set forth herein.

### BACKGROUND

1. Field

The following description relates to an antenna for a wireless communication terminal to improve hearing aid compatibility (HAC).

2. Discussion of the Background

Personal portable terminals, such as mobile phones, for wireless communication services have become lighter, smaller and multifunctional and consume less power than old devices. Antennas essential for communications between base stations and terminals are core components that initiate and complete signal input/output and determine speech quality.

In particular, a performance of a compact antenna may vary according to a shape, functionality, and material of a terminal in which the antenna is disposed, and hence, unlike other core components, a design of the antenna needs to be customized to each terminal model to obtain optimal performance.

Further, specific absorption rate (SAR), that is widely used as a measure for electromagnetic waves radiating from a mobile phone on a human body (especially, around the head), is restricted to a given level. For example, in Korea and the U.S.A., the maximum allowable SAR is 1.6 w/kg, and in Europe and Japan, the maximum allowable SAR is 2.0 w/kg. Thus, in designing an antenna for a mobile phone, SAR allowable range should be considered, as well as a shape, functionality, and material of the terminal.

In addition, in an effort to resolve difficulties that hearing aid users may have in using a mobile phone, the United States Federal Communications Commission (FCC) has strengthened the regulations that require all mobile devices to be tested and rated for hearing aid compatibility (HAC) before release of the product. As a result, in exporting mobile terminals by Korean communication device manufacturers, some importing countries may require a given number of mobile devices to conform to the HAC requirements. Accordingly, there is a need to develop mobile communication terminals that meet the strengthened HAC requirements.

FIG. 1 is a diagram illustrating an antenna configuration of a mobile communication terminal according to the related art.

Referring to FIG. 1, a signal contact point 110 is connected to a ground (GND) 120, and a first antenna pattern 140 extends from the signal contact point 110 and a second antenna pattern 130 extends from the ground 120. A signal outputted from the signal contact point 110 is radiated as radio waves from a first pattern or a second pattern. Radio waves in different frequency bands are radiated according to a length of an antenna pattern. That is, radio waves in a higher frequency band are radiated from the first antenna pattern 140 that has a relatively shorter length, and radio waves in a lower frequency band are radiated from the second antenna pattern 130 that has a relatively longer length.

However, if an antenna pattern is designed as shown in FIG. 1, more radio waves are radiated to an upper portion of the wireless communication terminal, and the radio waves may be focused on a sound receiving portion of the wireless communication terminal and generating a hot spot on the sound receiving portion, thereby causing a problem in hearing aid compatibility (HAC).

Therefore, an antenna that allows some radio waves radiated to an upper portion of a wireless communication terminal to be directed to a lower portion of the terminal to have better HAC and to decrease effects of radio waves.

### SUMMARY

Exemplary embodiments of the present invention provide an antenna for a mobile communication terminal which improves hearing aid compatibility and enhances speech quality.

Additional features of the invention will be set forth in the description which follows, and in part will be apparent from the description, or may be learned by practice of the invention.

Exemplary embodiments of the present invention provide an antenna having a signal contact point and a ground contact point, including an extension pattern portion to connect the ground contact point and a first point and to connect the signal contact point and the first point; a low-frequency band pattern portion extended from the first point, the low-frequency band pattern having a first length; and a high-frequency band pattern portion extended from the ground contact point, the high-frequency band pattern having a second length that is shorter than the first length.

Exemplary embodiments of the present invention provide an antenna for a wireless communication terminal, including an extension pattern portion to connect a ground contact point and a first point and to connect a signal contact point and the first point; a low-frequency band pattern portion having a first length to radiate a first radio wave having a first frequency; a high-frequency band pattern portion having a second length to radiate a second radio wave having a second frequency, wherein the low-frequency band pattern portion extends from the first point, the high-frequency band pattern portion extends from the ground contact point, and the first length is longer than the second length.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an antenna configuration of a mobile communication terminal according to the related art.

FIG. 2 is a diagram illustrating an antenna disposed in a wireless communication terminal for enhancing hearing aid compatibility (HAC) according to an exemplary embodiment of the present invention.

FIG. 3A is a diagram illustrating a radiation pattern of a conventional antenna configuration.

FIG. 3B and FIG. 3C are diagrams illustrating a radiation pattern of an antenna according to an exemplary embodiment of the present invention.

FIG. 4A is a diagram illustrating a HAC measurement of a conventional antenna disposed in a wireless communication terminal.

FIG. 4B is a diagram illustrating a HAC measurement of an antenna disposed in a wireless communication terminal having an extension pattern portion according to an exemplary embodiment of the present invention.

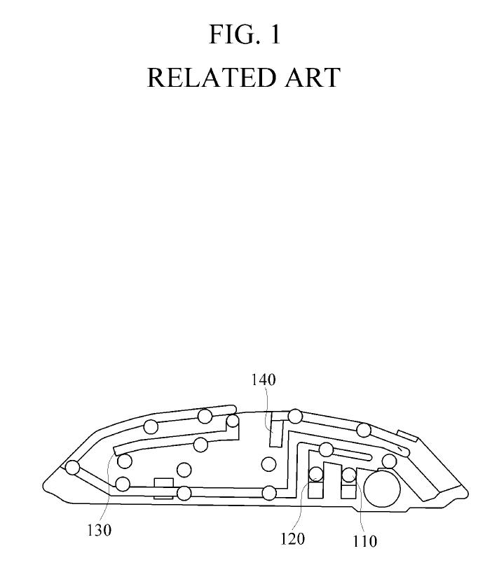

### DETAILED DESCRIPTION OF THE ILLUSTRATED EMBODIMENTS

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

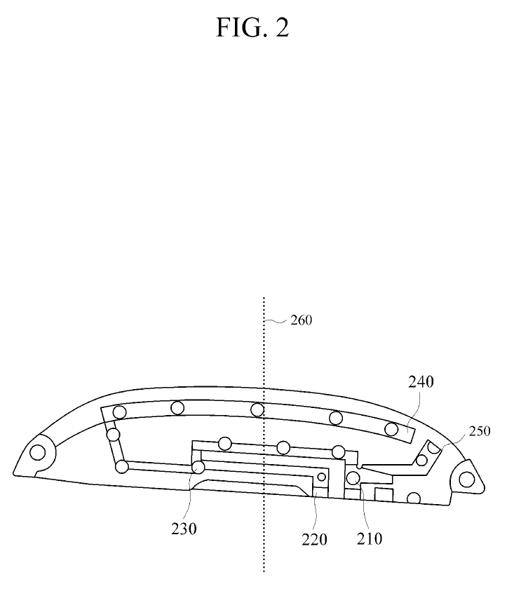

FIG. 2 is a diagram illustrating an antenna disposed in a wireless communication terminal for enhancing hearing aid compatibility (HAC) according to an exemplary embodiment of the present invention.

Referring to FIG. 2, the antenna may include a signal contact point 220, a ground contact point 210, and an extension pattern portion that has ends extended from each of the signal contact point 220 and the ground contact point 210 and being connected at a first point 230. The extension pattern portion may include a first extension pattern portion and a second extension pattern portion. The first extension pattern portion may have a first end connected to the ground contact point 210 and a second end connected to the first point 230. The second extension pattern portion may have a first end connected to the signal contact point 220 and a second end connected to the first point 230. The first extension pattern portion may be disposed between the second extension pattern portion and the low-frequency band pattern portion 240 as shown in FIG. 2. In addition, a low-frequency band pattern portion 240 extends from the first point 230 having a first length, and a high-frequency band pattern portion 250 extends from the ground contact point 210 having a second length that is shorter than the first length. As shown in FIG. 2, the first point may be located at a symmetrically opposite position or a similar position with respect to the ground contact point 210 or the signal contact point 220. The axis of the reflection about which the symmetry or near symmetry is taken may be a vertical axis 260 that passes through the middle of the wireless communication terminal as shown in FIG. 2.

A first radio wave having a lower frequency in a low frequency band may be radiated from the low-frequency band pattern portion 240 that has a relatively longer length than the high-frequency band pattern portion 250, and a second radio wave having a higher frequency in a high frequency band may be radiated from the high-frequency band pattern portion 250 that has a relatively shorter length than the low-frequency band pattern portion 240. The low-frequency band pattern portion 240 may have a ‘U’-shaped pattern extending from the first point 230. The high-frequency band pattern portion 250 may have a bent shape extending from the ground contact point 210. Further, the ground contact point 210, the signal contact point 220, the low-frequency band pattern portion 240, and the high-frequency band pattern portion 250 may each, individually, be bent or include multiple bends in a direction such that the antenna need not be planar; however, aspects are not limited thereto.

An electric signal outputted from the ground contact point 210 may pass through the first point 230 and may be radiated as the first radio wave through the low-frequency band pattern portion 240. A radiation pattern moves downward in a length between the ground contact point 210 and the first point 230. The antenna may be free from limitations of customization that is applied to each type of wireless communication terminal in a limited manner and may thus be applied in common to various types of wireless communication terminals such as bar-, slide-, qwerty slide-, and clamshell-types of wireless communication terminals.

The length from the ground contact point 210 to the first point 230 may be determined to be greater than or equal to 10% of the sum of the length from the ground contact point 210 to the first point 230 and the first length of the low-frequency band pattern portion 240. The length from the ground contact point 210 to the first point 230 may be longer than the length from the signal contact point 220 to the first point 230.

Further, the length from the ground contact point 210 to the first point 230 may fall within a range from 40% to 50% of the sum of the length from the ground contact point 210 to the first point 230 and the first length of the low-frequency band pattern portion 240.

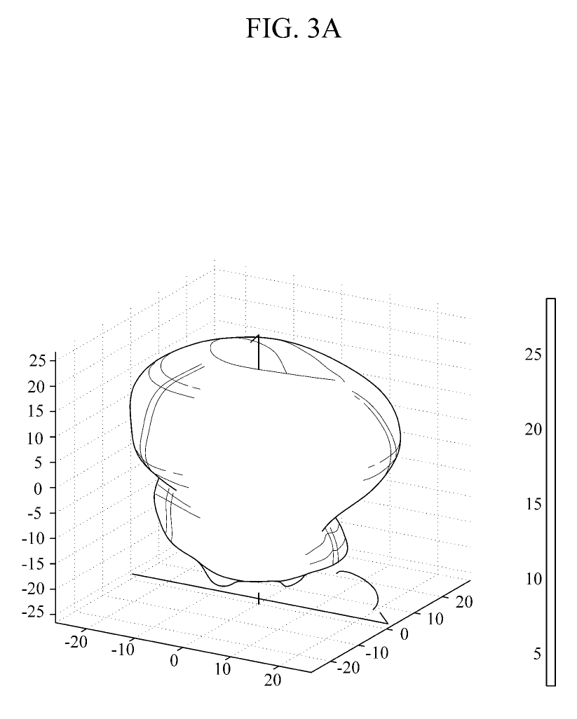

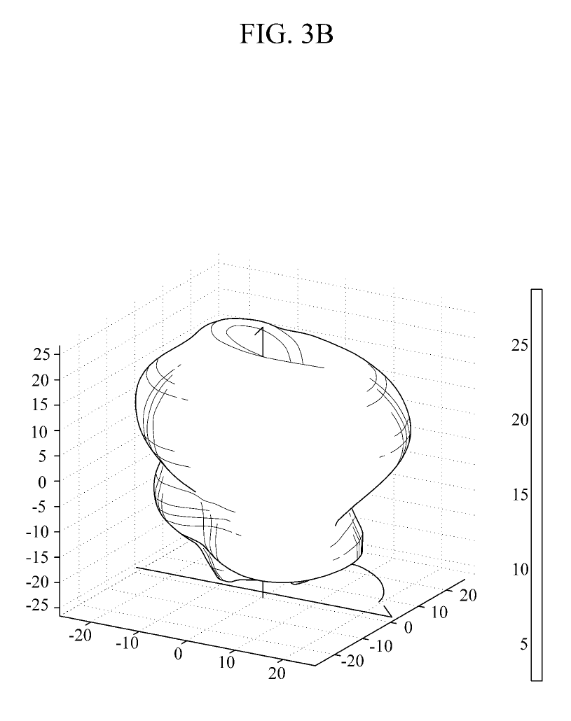

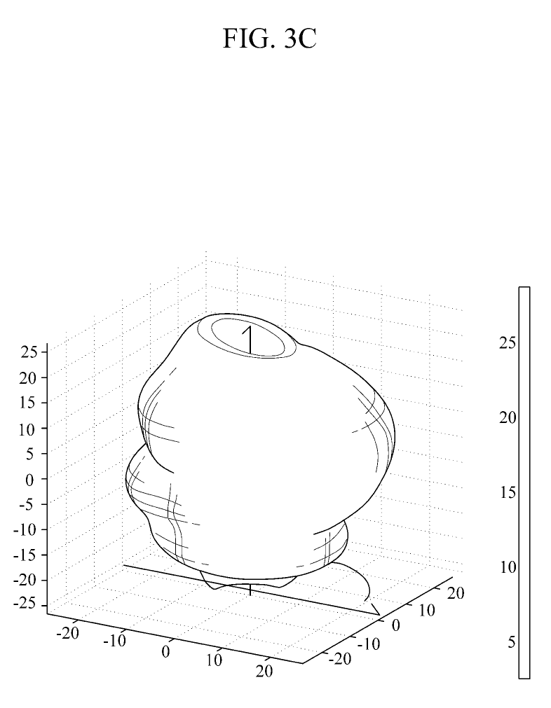

Changes in radiation pattern according to different antenna configurations will be described with reference to FIG. 3A, FIG. 3B, and FIG. 3C.

FIG. 3A is a diagram illustrating a radiation pattern of a conventional antenna configuration.

Referring to FIG. 3A, the radiation pattern shows radiation toward a front upper portion of a wireless communication terminal. In this antenna configuration, an HAC value may be increased.

FIG. 3B is a diagram illustrating a radiation pattern of an antenna according to an exemplary embodiment of the present invention.

Referring to FIG. 3B, if the length from the ground contact point 210 to the first point 230 (see FIG. 2) is about 10% of the sum of the length from the ground contact point 210 to the first point 230 and the first length of the low-frequency band pattern portion 240, the radiation pattern moves downward from the front upper portion of the wireless communication terminal. In this antenna configuration, an HAC value may decrease.

FIG. 3C is a diagram illustrating a radiation pattern of an antenna according to an exemplary embodiment of the present invention.

Referring to FIG. 3C, if the length from the ground contact point 210 to the first point 230 is about 15% of the sum of the length from the ground contact point 210 to the first point 230 and the first length, the radiation pattern shows that radiation at the front upper portion moves downward more than radiation pattern shown in FIG. 3B. In this antenna configuration, the HAC value may decrease.

According to the standard adopted by the FCC, a device that receives HAC rating of M3 or M4 meets or surpasses the HAC standard.

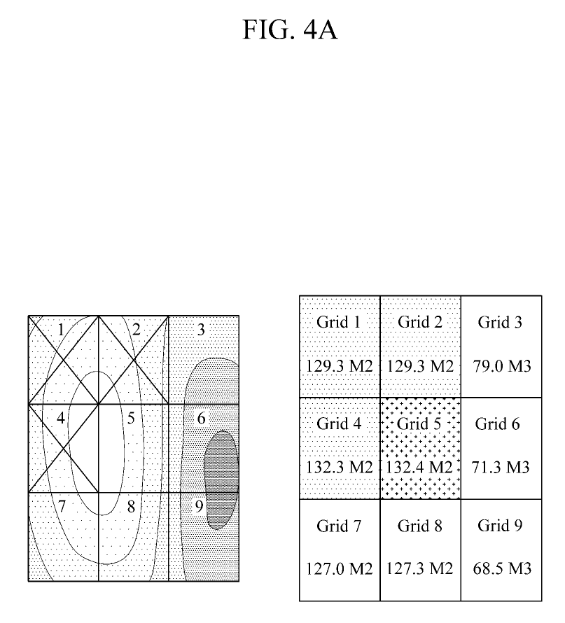

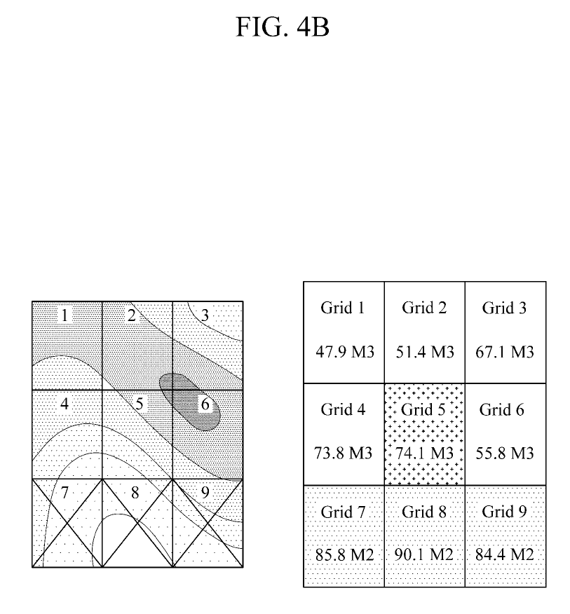

HAC measurement examples will be described with reference to FIG. 4A and FIG. 4B.

FIG. 4A is a diagram illustrating an HAC measurement of a conventional antenna disposed in a wireless communication terminal.

Referring to FIG. 4A, a large amount of radio waves are radiated to an upper portion of the wireless communication terminal, and thus a hot spot is formed around a receiver, resulting in increased HAC values. More specifically, in eight Grid regions except Grid 5, the consecutive top three HAC values, i.e., HAC values of Grid 1, Grid 2, and Grid 4, are removed. Then, among the remaining regions including Grid 5, Grid 5 has the largest value, 132.4 V/m, and the value of Grid 5 may be determined as an HAC value of the wireless communication terminal. The HAC value, 132.4 V/m, falls within M2, and thus cannot be satisfactory for the HAC standard.

FIG. 4B is a diagram illustrating a HAC measurement of an antenna disposed in a wireless communication terminal having an extension pattern portion according to an exemplary embodiment of the present invention.

Referring to FIG. 4B, a radiation pattern shows that radiation moves downward with respect to a wireless communication terminal, and thus a hot spot is formed at a lower portion of a receiver, thereby satisfying HAC. More specifically, in eight Grid regions except Grid 5, the consecutive top three HAC values, i.e., HAC values of Grid 7, Grid 8, and Grid 9, are removed. Then, among the remaining regions including Grid 5, Grid 5 has the largest HAC value, 74.1 V/m, and the value of Grid 5 may be determined as an HAC value of the wireless communication terminal. The HAC value of 74.1 V/m falls within M3, and thus meets the HAC standard.

Aspects of the present invention may provide an antenna for a wireless communication terminal that may improve HAC and minimize electromagnetic interference on a hearing aid user while the user is making a call using the wireless communication terminal.

Therefore, noise current may be reduced and speech quality may be enhanced.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An antenna having a signal contact point and a ground contact point, the antenna comprising:
an extension pattern portion to connect the ground contact point and a first point and to connect the signal contact point and the first point;
a low-frequency band pattern portion extended from the first point, the low-frequency band pattern having a first length; and
a high-frequency band pattern portion extended from the ground contact point the high-frequency band pattern having a second length that is shorter than the first length.

2. The antenna of claim 2, wherein a length from the ground contact point to the first point is greater than or equal to 10% of a sum of the length from the ground contact point to the first point and the first length.

3. The antenna of claim 1, wherein a length from the ground contact point to the first point falls within a range from 40% to 50% of a sum of the length from the ground contact point to the first point and the first length.

4. An antenna for a wireless communication terminal, the antenna comprising:
an extension pattern portion to connect a ground contact point and a first point and to connect a signal contact point and the first point;
a low-frequency band pattern portion having a first length to radiate a first radio wave having a first frequency; and
a high-frequency band pattern portion having a second length to radiate a second radio wave having a second frequency,
wherein the low-frequency band pattern portion extends from the first point, the high-frequency band pattern portion extends from the ground contact point, and the first length is longer than the second length.

5. The antenna of claim 4, wherein the extension pattern portion comprising:
a first extension pattern portion to connect the ground contact point and the first point; and
a second extension pattern portion to connect the signal contact point and the first point,
wherein the first extension pattern portion is disposed between the second extension pattern portion and the low-frequency band pattern portion.

6. The antenna of claim 4, wherein the first point and the ground contact point are located at symmetrically opposite positions in the wireless communication terminal.

7. The antenna of claim 4, wherein the first point and the signal contact point are located at symmetrically opposite positions in the wireless communication terminal.

8. The antenna of claim 4, wherein a length from the ground contact point to the first point is greater than or equal to 10% of a sum of the length from the ground contact point to the first point and the first length.

9. The antenna of claim 4, wherein a length from the ground contact point to the first point falls within a range from 40% to 50% of a sum of the length from the ground contact point to the first point and the first length.

10. The antenna of claim 5, wherein the low-frequency band pattern portion has a U-shaped pattern and the high-frequency band pattern portion has a bent shape.
